(19) United States
(12) Patent Application Publication
(10) Pub. No.: US 2025/0239900 A1
(43) Pub. Date: Jul. 24, 2025

(54) COOLING STRUCTURE FOR ELECTRIC MOTOR

(71) Applicant: TOYOTA JIDOSHA KABUSHIKI KAISHA, Toyota-shi (JP)

(72) Inventors: Shingo NAGAI, Toyota-shi (JP); Ken JOZAKI, Seto-shi (JP); Yutaro IKEDA, Toyota-shi (JP)

(73) Assignee: TOYOTA JIDOSHA KABUSHIKI KAISHA, Toyota-shi (JP)

(21) Appl. No.: 18/988,970

(22) Filed: Dec. 20, 2024

(30) Foreign Application Priority Data
Jan. 23, 2024 (JP) 2024-008305

(51) Int. Cl. H02K 1/20

(52) U.S. Cl. CPC H02K 1/20

(57) ABSTRACT

A cooling structure for an electric motor comprising: slots that open toward an inner peripheral side of a stator yoke and continue in an axial direction being formed in the stator yoke; coils being held inside the slots; and a stator with coil ends projecting on both end sides of the stator yoke in the axial direction being cooled with a cooling fluid, the cooling structure for an electric motor including inlets provided at one end portion of the stator yoke in the axial direction on a side further outward than the coil ends in a radial direction to allow the cooling fluid to flow into the inlets, and cooling flow paths that are formed at positions closer to the slots than an outer peripheral surface of the stator yoke from one end portion side to another end portion side of the stator yoke.

### CROSS-REFERENCE TO RELATED APPLICATION

This application claims priority to Japanese Patent Application No. 2024-008305 filed on Jan. 23, 2024, incorporated herein by reference in its entirety.

### BACKGROUND

### 1. Technical Field

The present disclosure relates to a structure for cooling a stator holding a coil in an electric motor by supplying a cooling fluid such as oil to the stator.

### 2. Description of Related Art

A device for cooling a motor is described in US 2023/0008953 A. The device is configured to perform cooling by causing a cooling fluid to flow into an interior of a fixed iron core in an axial direction thereof. In other words, a plurality of annular electromagnetic steel plates is stacked to constitute the fixed iron core, a plurality of teeth extending toward a center of the fixed iron core is provided on an inner peripheral side thereof, and a coil is held in slots between the teeth. A plurality of cooling flow paths for distributing a cooling fluid is formed at an outer peripheral portion of the fixed iron core, which is greatly separated outward from the slots in a radial direction, in an aligned manner in a circumferential direction. In other words, through-holes are opened at outer peripheral portions of the electromagnetic steel plates, and the electromagnetic steel plates are stacked such that the through-holes are connected in the axial direction, and the cooling flow path is thereby formed by the through-holes. Also, each electrical steel plate has a projecting portion projecting outward in the radial direction, and a so-called bead-shaped protruding portion extending in the axial direction is formed by the projecting portion at the outer peripheral portion of the fixed iron core by the electromagnetic steel plates being stacked. A bolt hole through which a bolt for fastening or fixing the electromagnetic steel plates is inserted is provided on the inner side of the protruding portion in the axial direction, and a flow-in hole is provided in parallel with the bolt hole. An arc-shaped groove or a slit centered on the center of the fixed iron core is formed at an outer peripheral portion of the electromagnetic steel plate located at substantially the central portion of the fixed iron core in the axial direction and at a position corresponding to the cooling flow path, and the groove or the slit serves as a header for each cooling flow path. Furthermore, a communication portion that causes the groove or the slit to communicate with the flow-in hole is formed. Therefore, once the cooling fluid is supplied to a flow-in path by a pump or the like, the cooling fluid is supplied in a dispersed manner to each cooling flow path via the communication passage and the groove or slot described above at a substantially central portion of the fixed iron core in the axial direction. The cooling fluid flows in both directions in the axial direction from substantially the central portion of the fixed iron core in the axial direction, flows out of the cooling flow path at end portions of the fixed iron core, and falls onto the coil ends. In other words, substantially the central portion of the cooling flow path in the axial direction serves as the flow-in portion for the cooling fluid, and both end portions in the axial direction serve as the flow-out portions.

### SUMMARY

The temperature of the fixed iron core rises due to a change in Joule heat or magnetic flux caused by a current flowing through the coil. The heat is transmitted through the electromagnetic steel plates on the outer peripheral side, reaches the cooling flow path, and is conveyed to the outside with the cooling fluid flowing therethrough. In other words, the fixed iron core is cooled from the outer peripheral portion side with the cooling fluid. However, heat generation in the fixed iron core is mainly caused by the coil. On the other hand, cooling is performed at an outer peripheral portion separated from the coil in the above-described configuration described in US 2023/0008953 A. Therefore, the temperature of the fixed iron core may increase due to heat storage between the coil or the teeth holding the coil and the cooling flow path. In other words, a thermal resistance from the coil to the cooling fluid is high, and there is room for improvement in terms of a cooling effect.

In addition, a flow-out portion for the cooling fluid toward a coil end is at a position greatly separated from the coil end on the upper side thereof due to the cooling flow path provided at the outer peripheral portion of the fixed iron core. As a result, the coverage of the coil ends with the cooling fluid becomes low, and there is a likelihood that the coil ends are not always able to be sufficiently cooled.

The present disclosure was made by focusing on the aforementioned technical problem, and an object of thereof is to provide a cooling structure for an electric motor capable of improving cooling performance of a stator including a coil.

In order to achieve the above object, the present disclosure provides a cooling structure for an electric motor, slots that open toward an inner peripheral side of a stator yoke obtained by stacking annular steel plates and continue in an axial direction being formed in the stator yoke, coils being held inside the slots, and a stator with coil ends projecting on both end sides of the stator yoke in the axial direction being cooled with a cooling fluid, the cooling structure for an electric motor including inlets provided at one end portion of the stator yoke in the axial direction on a side further outward than the coil ends in a radial direction to allow the cooling fluid to flow into the inlets, and
cooling flow paths that are formed at positions closer to the slots than an outer peripheral surface of the stator yoke from one end portion side to another end portion side of the stator yoke in the axial direction to allow the cooling fluid to flow through the cooling flow paths, in which end portions of the cooling flow paths on one side communicate with the inlets of the stator yoke, and
the end portions of the cooling flow paths on another side open on the other end portion side of the stator yoke.

In the present disclosure, an opening shape of the cooling flow paths may be a shape in which a dimension measured in a circumferential direction of the stator yoke is smaller than a dimension measured in a radial direction of the stator yoke.

In the present disclosure, an opening shape of the inlets may be a shape in which a dimension measured in a radial direction of the stator yoke is smaller than a dimension measured in a circumferential direction of the stator yoke.

In the present disclosure, a header portion that is provided on the one end portion side of the stator yoke in the axial direction as an annular blank space that covers the inlets and distributes and supplies the cooling fluid to each of the inlets may be provided, and
a flow-out hole that supplies the cooling fluid to the coil ends projecting on the one end portion side of the stator yoke in the axial direction may be formed in the header portion.

In the present disclosure, a third steel plate that is sandwiched between a first steel plate provided with the inlets and a second steel plate in which the cooling flow paths are formed may be included,
communication hole portions that open from both the inlets provided in the first steel plate and the cooling flow paths provided in the second steel plate may be formed in the third steel plate, and
the communication hole portions may cause the inlets and the cooling flow paths to communicate with each other.

According to the present disclosure, the inlets for supplying the cooling fluid to the inside of the stator yoke are provided on the side closer to the outer periphery than the coil ends. Therefore, there is an advantage in that a degree of freedom in designing the shape of the inlets is increased, for example, the size of the shape of the inlets can be increased as needed while an interference between the inlets and the coil ends is avoided. In addition, the cooling flow paths through which the cooling fluid flows inside the stator yoke are provided at a position closer to the slots than the outer peripheral surface of the stator yoke, that is, at a position closer to the coil. Therefore, cooling is achieved with the cooling fluid at a position close to the coil that generates heat through operations. In other words, a thermal resistance between the coil and the cooling fluid is low, and as a result, the stator yoke can be effectively cooled. Furthermore, opening ends or outlets of the cooling flow paths are located at a position bear the coil end at the other end of the stator yoke in the axial direction, and the cooling fluid thus flows down without deviating from the coil end. As a result, a coverage of oil can be improved. According to the present disclosure, the cooling fluid carries away a large amount of heat as described above, and cooling performance of the stator can thus be improved.

The opening shape of the cooling flow paths in the present disclosure, that is, the shape taken along a plane that is perpendicular to a center axis of the stator yoke is a shape with a small dimension in the circumferential direction. The location where the cooling flow paths are provided is a portion close to the slots (teeth forming the slots), which is a location where a magnetic flux faces the radial direction or a direction close to the radial direction of the stator yoke. Therefore, the width or area of the cooling flow paths blocking the magnetic flux is reduced, and it is possible to reduce deterioration or degradation of magnetic characteristics.

Similarly, an opening shape of the inlets in the present disclosure, that is, the shape taken along the plane that is perpendicular to the center axis of the stator yoke is a shape with a small dimension in the radial direction. The location where the inlets are provided is a portion on the outer peripheral side of the stator yoke, which is a location where the magnetic flux faces the circumferential direction or a direction close to the circumferential direction. Therefore, the width or area of the inlets blocking the magnetic flux is reduced, and it is thus possible to reduce deterioration or degradation of magnetic characteristics due to the inlets.

Since the header portion in the present disclosure is formed as an annular blank space which each inlet aligned in the circumferential direction is caused to face, at the end portion of the stator yoke in the axial direction, the cooling fluid is supplied to the header portion. Thus, the cooling fluid can be distributed and supplied to the cooling flow paths that are in communication from all the inlets. Furthermore, the cooling fluid can be dropped from the flow-out hole to the coil ends located on the inner peripheral side of the header portion to cool the coil ends.

In the present disclosure, it is possible to form the inlets, the cooling flow paths, and the communication hole portions by opening the holes penetrating through the ring-shaped steel plates in a plate thickness direction and stacking the steel plates such that the holes communicate with each other. This facilitates working and assembling, components projecting outward are not particularly needed, and it is thus possible to simplify the shape as a whole.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for explaining a general configuration of an electric motor according to an embodiment of the present disclosure;

FIG. 2 is a front view showing a part of a stator yoke for describing an example of a position and an opening shape of an inlet and a cooling flow path and a communication hole portion;

FIG. 3 is a schematic cross-sectional view showing a part of one end portion of the stator yoke in the axial direction;

FIG. 4 is a front view of a portion of an electromagnetic steel plate for explaining the orientation of the magnetic flux; and

FIG. 5 is a diagram illustrating an example of an opening shape of a communication hole portion.

### DETAILED DESCRIPTION OF EMBODIMENTS

Embodiments of the present disclosure will now be described with reference to the accompanying drawings. Note that the embodiments described below are merely examples of the implementation of the present disclosure, and do not limit the present disclosure.

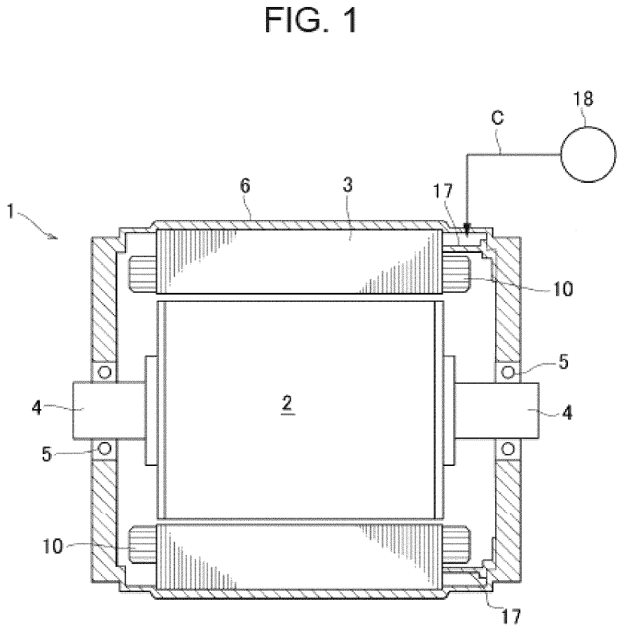

FIG. 1 is a schematic diagram illustrating an overall configuration of an electric motor 1 according to an embodiment of the present disclosure. The example shown here is a permanent magnet type synchronous electric motor, the basic configuration of which is substantially the same as the conventional electric motor except for the structure for cooling. That is, the cylindrical stator 3 is arranged concentrically on the outer peripheral side of the rotor 2. The rotor 2 holds a permanent magnet (not shown), and a rotor shaft 4 protruding on both sides in the axial direction thereof is rotatably held by a motor case 6 via a bearing 5. The motor case 6 is a hollow member covering the whole of the electric motor 1, and the stator 3 is fixed to an inner peripheral surface thereof.

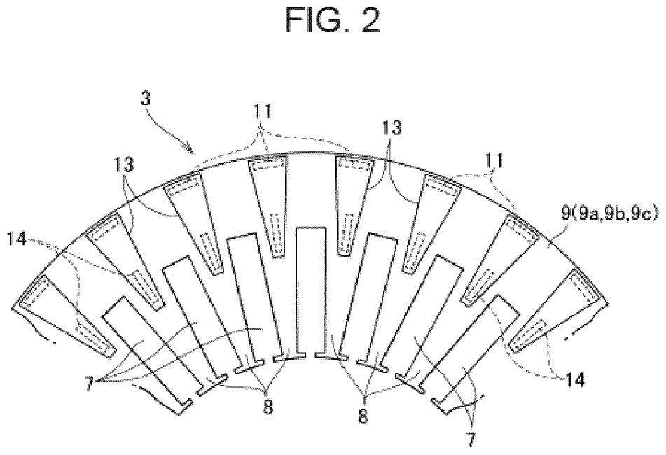

The stator 3 is formed by laminating a plurality of annular thin electromagnetic steel plates. In the inner peripheral portion of each electromagnetic steel plate, as shown in part in FIG. 2, slots 7 open toward the inner peripheral side are formed side by side in the circumferential direction, and a portion between the slots 7 is a tooth 8. The respective electromagnetic steel plates are stacked with their postures aligned so that the slots 7 or the teeth 8 are aligned in the direction of the central axis of the stator 3, and thus the stator yoke (fixed iron core) 9 is configured. In each slot 7, for example, a series of connected coils in each of three phases are arranged, and their folded end portions (coil ends) 10 protrude to both end portions in the axial direction of the stator yoke 9.

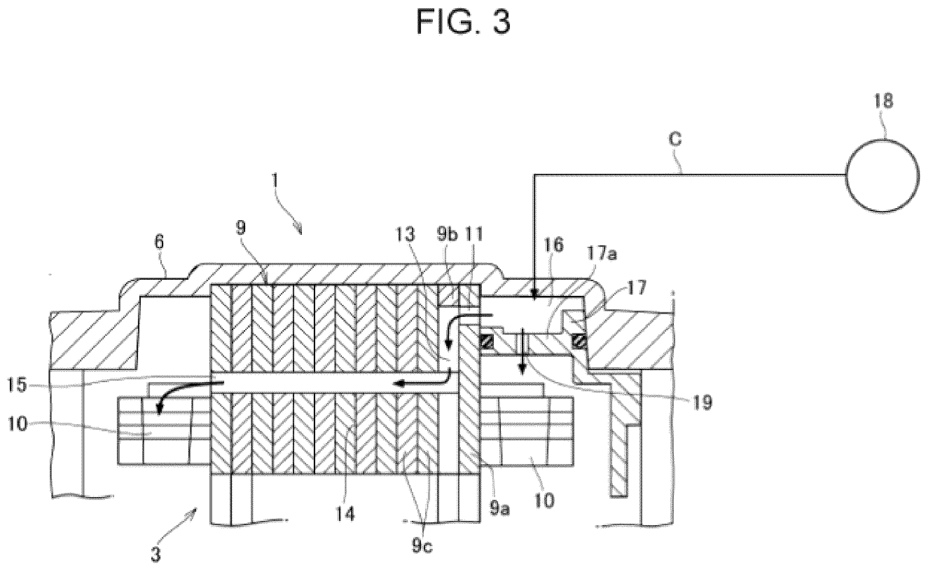

The cooling structure in the embodiment of the present disclosure is configured to cool the electric motor 1 (in particular, the stator 3 and the coil end 10) by flowing the cooling fluid C inside the stator yoke 9 configured as described above. Specifically, FIG. 3 schematically shows a part of both ends of the stator yoke 9 in the axial direction. Among the electromagnetic steel plates constituting the stator yoke 9, a plurality of electromagnetic steel plate 9a located at the right end of FIG. 3, through holes penetrating in the thickness direction thereof are drilled, and the inlet 11 is formed by these through holes. As shown in FIG. 2, the inlet 11 is formed on the outer peripheral side of the coil end 10 so as not to interfere with a portion on the outer peripheral side of the electromagnetic steel plate (stator yoke 9), more specifically, the coil end 10 described above. Further, the inlet 11 is, for example, a through portion having an opening width smaller than the maximum width of the teeth 8, and is formed in a plurality at predetermined intervals in the circumferential direction on the outer peripheral portion of the electromagnetic steel plate (stator yoke 9). The electromagnetic steel plate 9a provided with the inlet 11 corresponds to the first steel sheet in the embodiment.

Since the inlet 11 is provided on the outer peripheral side of the coil end 10, there is little room for interference with the coil end 10, and therefore the opening area (size) and shape thereof can be appropriately set as necessary. That is, the degree of freedom in design including the shape of the inlet 11 is high. Further, the opening shape of the inlet 11 (the cross-sectional shape when cut in a plane perpendicular to the central axis of the stator yoke 9) can be appropriately determined as necessary. However, in consideration of the direction of the magnetic flux 12 generated in the stator yoke 9, it is preferable to have a shape described below.

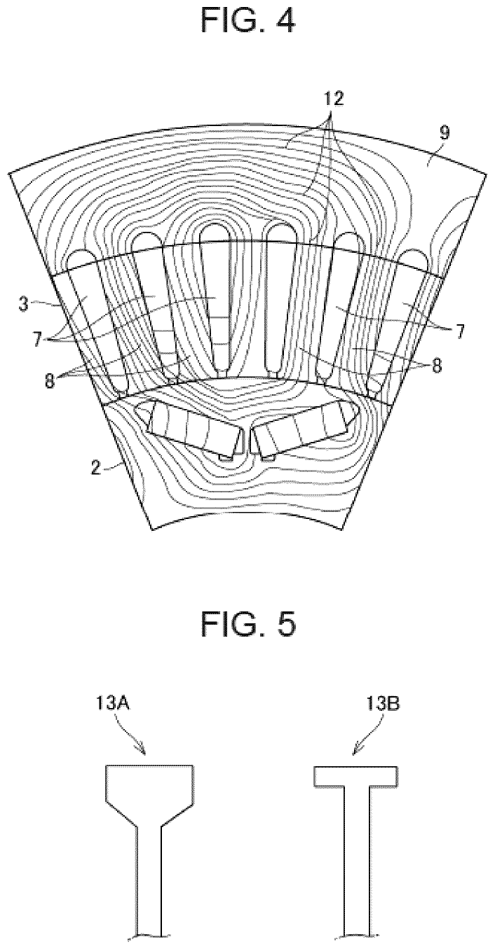

FIG. 4 is a curve showing the direction of the magnetic flux 12 when the stator yoke 9 (electromagnetic steel plate) is viewed from the axial direction. In the portion on the outer peripheral side of the teeth 8, the magnetic flux 12 is generated so as to connect the teeth 8 across the slot 7, the portion of the teeth 8 magnetic flux 12 toward the longitudinal direction (the radial direction of the electromagnetic steel plate or stator yoke 9) is generated. Since the inlet 11 is a hollow portion through which the cooling fluid C flows, the portion where the magnetic flux 12 is generated (or flows) is reduced and the magnetic flux 12 is blocked. In consideration of the direction of the magnetic flux 12, the opening shape of the inlet 11, the cross-sectional area perpendicular to the direction of the magnetic flux 12 (the area facing the magnetic flux 12), while securing the area as a flow path of the inlet 11, in order to reduce, the dimension in the radial direction is a circumferential direction (or a direction perpendicular to the radial direction) it is preferable to have a shape such as a smaller rectangular or elliptical or rhombic dimension. By doing so, it is possible to reduce the influence on the magnetic flux 12 while securing the flow path cross-sectional area of the cooling fluid C, and to avoid or suppress the deterioration of the magnetic characteristics or the performance of the electric motor 1.

A plurality of other electromagnetic steel plate 9b adjoining the electromagnetic steel plate in which the penetrating portion constituting the inlet 11 is formed, a long penetrating portion in the radial direction of the electromagnetic steel plate 9b is formed, the penetrating portion is formed by laminating the electromagnetic steel plate so as to overlap in the axial direction communication hole portion 13 is formed. The communication hole portion 13 is provided corresponding to the inlet 11 described above. That is, in the circumferential direction of the electromagnetic steel plate, the communication hole portion 13 is provided at the same position as the inlet 11. Further, the end portion on the outer peripheral side (the outer side in the radial direction of the electromagnetic steel plate) of each of the communication hole portions 13 overlaps with the inlet 11. That is, each of the plurality of communication hole portions 13 communicates with the inlet 11. 9b of the electromagnetic steel plate in which the communication hole portion 13 is formed corresponds to the third steel plate in the embodiment.

A cooling flow path 14 through which the cooling fluid C supplied from the inlet 11 through the communication hole portion 13 flows is formed in the stator yoke 9. That is, in the electromagnetic steel plate 9c from the electromagnetic steel plate contacting the electromagnetic steel plate 9b in which the communication hole portion 13 is formed to the other end portion of the stator yoke 9 (the left end in FIG. 3), the penetrating portion penetrating in the plate thickness direction is formed, by laminating the electromagnetic steel plates so that the penetrating portions overlap each other, the cooling flow path 14 is formed. The electromagnetic steel plate 9c in which the cooling flow path 14 is formed corresponds to the second steel sheet in the embodiment of the present disclosure in which the electromagnetic steel plate 9b corresponding to the third steel plate is sandwiched between the electromagnetic steel plate 9a corresponding to the first steel sheet.

The cooling flow path 14 is provided at a position closer to the above-described slot 7 or the tooth 8 than the outer peripheral surface of the electromagnetic steel plate or the stator yoke 9. For example, as shown in FIG. 2, a part of the inner peripheral side enters the tooth 8 and is provided at a position overlapping the slot 7 when viewed in the circumferential direction. Further, the open end of the cooling flow path 14 on one end side (right end side in FIG. 3) in the axial direction of the stator yoke 9 is positioned corresponding to the inner end portion in the radial direction of the communication hole portion 13 described above. That is, the same number of cooling flow paths 14 as the teeth 8, are provided side by side in the circumferential direction, the respective cooling flow paths 14 communicate with the communication hole portion 13, and therefore, one end portion of the inlet 11 and the cooling flow paths 14 described above are connected via the communication hole portion 13. The other end portion of the cooling flow path 14 (the left end in FIG. 3) is open to the side surface of the stator yoke 9 and serves as an outlet 15. Therefore, the outlet 15 is disposed close to the coil end 10, such as directly above the coil end 10, so as to drop the cooling fluid C that has flowed out to the coil end 10.

The shape of the opening of the cooling flow path 14 (the cross-sectional shape when cut in a plane perpendicular to the central axis of the stator yoke 9) can be determined as appropriate as necessary in the same manner as for the inlet 11 described above. However, in consideration of the direction of the magnetic flux 12 generated in the stator yoke 9, it is preferable to have a shape described below. As described with reference to FIG. 4, in a portion close to the teeth 8, the direction of the magnetic flux 12 is the longitudinal direction of the teeth 8 (the radial direction of the electromagnetic steel plate or the stator yoke 9) or a direction close thereto. Further, the cooling flow path 14 is a hollow portion through which the cooling fluid C flows, and acts to reduce a portion where the magnetic flux 12 is generated (or flows) and to block the magnetic flux 12. Therefore, the opening shape of the cooling flow path 14, the cross-sectional area perpendicular to the direction of the magnetic flux 12 (the area facing the magnetic flux 12), while securing the area as a flow path of the cooling flow path 14, in order to reduce, as shown in FIG. 2, the dimension in the circumferential direction is smaller than the dimension in the radial direction rectangular or elliptical or diamond shape (so-called longitudinal shape in FIG. 2) it is preferable to. By doing so, it is possible to reduce the influence on the magnetic flux 12 while securing the flow path cross-sectional area of the cooling fluid C, and to avoid or suppress the deterioration of the magnetic characteristics or the performance of the electric motor 1.

It should be noted that the above-described communication hole portion 13 has only to function so as to communicate the inlet 11 and the cooling flow path 14, and thus can have an appropriate opening shape within the range. Although FIG. 2 shows a trapezoidal communication hole portion 13 having a narrow width on the inner peripheral side, other than this, for example, as shown in FIG. 5, a shape 13A or a T-shaped 13B in which a portion on the outer peripheral side is enlarged and a portion on the inner peripheral side is narrowed may be used.

Next, a configuration for supplying the cooling fluid C to each of the inlet 11 will be described. The end face of the stator yoke 9 each inlet 11 is open is provided with a header portion 16 which is a space covering each inlet 11. That is, the header portion 16 is configured as an annular space defined by the guide member 17 disposed between the inlet 11 and the coil end 10 and a part of the motor case 6. The guide member 17 has a cylindrical shape as a whole, and is sandwiched between a side surface of an electromagnetic steel plate (the rightmost electromagnetic steel plate in FIG. 3) on which the inlet 11 is formed and an inner surface of the motor case 6 opposed to the side surface, and is in a liquid-tight state by interposing a sealing material such as an O-ring with respect to both the side surface of the electromagnetic steel plate and the inner surface of the motor case 6. Therefore, a part of the guide member 17 on the outer periphery of the cylindrical portion 17a becomes a header portion 16 which is a space closed together with the motor case 6, and the respective inlets 11 are opened toward the header portion 16.

A pump 18 for supplying a cooling fluid (e.g., oil) C is connected to the header portion 16. A flow-out hole 19 is formed in the cylindrical portion 17a of the guide member 17 so as to supply the cooling fluid C toward the coil end 10 on the inner periphery thereof. Further, the header portion 16 may communicate with a gap between the outer peripheral surface of the stator yoke 9 and the inner peripheral surface of the motor case 6, or may be in a liquid-tight state. In order to make the liquid-tight state, an appropriate sealing material such as an O-ring may be interposed between the end surface of the stator yoke 9 in the axial direction and the motor case 6.

Next, the operation of the above-described cooling structure will be described. When the coil is energized to rotate the electric motor 1 or the rotor 2 is forcibly rotated by an external force to cause the electric motor 1 to function as a generator, heat is generated in the coil. In addition, heat is generated by a change in magnetic flux in the stator yoke 9. In this case, when the cooling fluid C such as oil is supplied to the header portion 16 by the pump 18, the cooling fluid C is distributed and supplied to the inlet 11 opening toward the header portion 16. The cooling fluid C passes through the communication hole portion 13 and is sent to the cooling flow path 14 extending in the axial direction inside the stator yoke 9. Since the cooling flow path 14 is provided at a position close to the slot 7 or the coil as described above, the cooling fluid C flows in the vicinity of the coil having a large calorific value and removes heat from its surroundings. That is, since the thermal resistance between the coil and the cooling fluid C is close to each other is reduced, it is possible to efficiently cool the coil through the stator yoke 9.

The cooling fluid C flows toward the other end in the axial direction of the stator 3 while cooling the coil and the stator yoke 9 by removing heat in this way, and flows out from the outlet 15 at the other end. As described above, the cooling flow path 14 is formed at a position close to the coil. Therefore, the outlet 15 which is the open end is also close to the coil end 10, and therefore, the cooling fluid C ejected from the outlet 15 is immediately jetted to the coil end 10, the coverage of the coil end 10 by the cooling fluid C is increased. That is, the cooling fluid C can be efficiently sprayed onto the coil end 10, and heat can be removed from the coil end 10 to be cooled.

On the other hand, a part of the cooling fluid C supplied to the header portion 16 is supplied from the flow-out hole 19 provided on the cylindrical portion 17a of the guide member 17 constituting the header portion 16 toward the coil-end 10 on the inner circumference of the cylindrical portion 17a. As a result, both of the coil ends 10 protruding to both sides in the axial direction of the stator 3 are cooled by the cooling fluid C.

The cooling fluid C supplied toward each coil end 10 flows down to the lower side of the electric motor 1, and then returns to a storage portion such as an oil pan (not shown). Thereafter, it is pumped again by the pump 18 and supplied to the header portion 16. Since the cooling fluid C is circulated in this way, it is preferable to provide a radiator (or a cooler) in the middle of the circulation path to cool the cooling fluid C.

The cooling fluid C described above is, for example, oil and functions to block the magnetic flux 12. However, as described above, the inlet 11 and the cooling flow path 14 filled with the cooling fluid C are configured such that the area (or projected area) of the plane perpendicular to the direction of the magnetic flux 12 is smaller than the area in the direction parallel to the direction of the magnetic flux 12. Therefore, interruption or shielding of the magnetic flux 12 by providing the inlet 11 and the cooling flow path 14 can be suppressed as much as possible in a state where the flow path cross-sectional area of the inlet 11 and the cooling flow path 14 is secured. That is, in the above-described configuration, it is possible to avoid or suppress deterioration in the magnetic characteristics of the stator 3 or the performance of the electric motor 1.

Further, the inlet 11, the communication hole portion 13, and the cooling flow path 14 described above can be configured by forming through-holes in the electromagnetic steel plate constituting the stator yoke 9 by, for example, press working, and laminating the electromagnetic steel plates so as to align the through-holes. Since the process of drilling the through-hole and the lamination operation of the electromagnetic steel plate are not particularly different from the manufacturing operation of the conventional stator, according to the embodiment of the present disclosure, it is possible to easily obtain the stator 3 or the electric motor 1 having excellent cooling effect. In other words, the electric motor 1 having excellent thermal characteristics can be obtained at low cost.

It should be noted that the present disclosure is not limited to the above-described embodiments, and can be appropriately modified within the scope of the above-described functions and effects. For example, the communication hole portion in the present disclosure may be configured as a hole portion continuous in the radial direction of the stator yoke, the hole portion extending to the middle from the inlet 11 to the cooling flow path 14 is formed in a predetermined electromagnetic steel plate, the other electromagnetic steel plate adjacent thereto, the hole portion from the hole portion to the cooling flow path 14 to form another hole portion, it may be configured to constitute a communication hole portion by these two hole portions. Further, the shape of the guide member 17 constituting the header portion 16 may be an appropriate shape depending on the shape of the inside of the motor case 6. Further, the steel sheet provided with the inlet or the steel sheet provided with the communication hole portion may be a plate material other than the electromagnetic steel plate.

What is claimed is:

1. A cooling structure for an electric motor comprising:
slots that open toward an inner peripheral side of a stator yoke obtained by stacking annular steel plates and continue in an axial direction being formed in the stator yoke;
coils being held inside the slots; and
a stator with coil ends projecting on both end sides of the stator yoke in the axial direction being cooled with a cooling fluid, the cooling structure for an electric motor including
inlets provided at one end portion of the stator yoke in the axial direction on a side further outward than the coil ends in a radial direction to allow the cooling fluid to flow into the inlets, and
cooling flow paths that are formed at positions closer to the slots than an outer peripheral surface of the stator yoke from one end portion side to another end portion side of the stator yoke in the axial direction to allow the cooling fluid to flow through the cooling flow paths, wherein
end portions of the cooling flow paths on one side communicate with the inlets of the stator yoke, and
the end portions of the cooling flow paths on another side open on the other end portion side of the stator yoke.

2. The cooling structure for an electric motor according to claim 1, wherein an opening shape of the cooling flow paths is a shape in which a dimension measured in a circumferential direction of the stator yoke is smaller than a dimension measured in a radial direction of the stator yoke.

3. The cooling structure for an electric motor according to claim 1, wherein an opening shape of the inlets is a shape in which a dimension measured in a radial direction of the stator yoke is smaller than a dimension measured in a circumferential direction of the stator yoke.

4. The cooling structure for an electric motor according to claim 1, comprising a header portion that is provided on the one end portion side of the stator yoke in the axial direction as an annular blank space that covers the inlets and distributes and supplies the cooling fluid to each of the inlets, wherein a flow-out hole that supplies the cooling fluid to the coil ends projecting on the one end portion side of the stator yoke in the axial direction is formed in the header portion.

5. The cooling structure for an electric motor according to claim 1, comprising a third steel plate that is sandwiched between a first steel plate provided with the inlets and a second steel plate in which the cooling flow paths are formed, wherein:
communication hole portions that open from both the inlets provided in the first steel plate and the cooling flow paths provided in the second steel plate are formed in the third steel plate; and
the communication hole portions cause the inlets and the cooling flow paths to communicate with each other.
